(19) United States
(12) Patent Application Publication
(10) Pub. No.: US 2026/0249451 A1
(43) Pub. Date: Aug. 27, 2026

(54) INFORMATION PROCESSING APPARATUS, LEARNING MODEL, AND INFORMATION PROCESSING METHOD

(71) Applicant: SONY GROUP CORPORATION, TOKYO (JP)

(72) Inventors: KIRILL VANHEERDEN, TOKYO (JP); RYO TERASAWA, TOKYO (JP); YASUHIRO MATSUDA, TOKYO (JP)

(21) Appl. No.: 18/578,317

(22) PCT Filed: Mar. 3, 2022
(86) PCT No.: PCT/JP2022/009057

§ 371 Date: Jan. 11, 2024

(30) Foreign Application Priority Data
Aug. 2, 2021 (JP) 2021-126389

(51) Int. Cl. B25J 9/16

(52) U.S. Cl. CPC B25J 9/163; B25J 9/1676

(57) ABSTRACT

A learning time and an estimation time are shortened by reducing a size of a neural network. There is provided an information processing apparatus including a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

### TECHNICAL FIELD

The present technology relates to an information processing apparatus, a learning model, and an information processing method.

### BACKGROUND ART

Conventionally, for example, a neural network is used for motion planning of a controlled device such as a robot.

For example, in the technologies disclosed in Patent Document 1, Patent Document 2, Non-Patent Document 1, and Non-Patent Document 2, it is disclosed that the neural network is caused to perform machine learning by inputting map data regarding the environment around the robot to the neural network.

### CITATION LIST

### Patent Document

Patent Document 1: WO 2019/239680
Patent Document 2: Japanese Patent Application Laid-Open No. 2018-190241

### Non-Patent Document

Non-Patent Document 1: L. Bouhalassa, L. Benchikh, Z. Ahmed-Foitih, K. Bouzgou, “Path Planning of the Manipulator Arm FANUC Based on Soft Computing Techniques”, International Review of Automatic Control, 2020, 13 (4), pp. 171-181
Non-Patent Document 2: A. H. Qureshi, J. Dong, A. Choe, M. C. Yip, “Neural Manipulation Planning on Constraint Manifolds”, IEEE Robotics and Automation Letters, 2020, Vol. 5, No. 4, pp. 6089-6096

### SUMMARY OF THE INVENTION

### Problems to be Solved by the Invention

However, in Patent Document 1, Patent Document 2, Non-Patent Document 1, and Non-Patent Document 2 described above, the entire environment is input to the neural network as map data. Thus, the number of neurons for grasping the environment tends to increase. An increase in the number of neurons causes a problem that the processing time for the neural network to learn or estimate becomes long. In Non-Patent Document 2, a 3D voxel map, which is a feature amount of the entire environment, is compressed into a data set, but since there is no change in grasping the entire environment, the above problem has not been solved.

Therefore, a main object of the present technology is to provide an information processing apparatus, a learning model, and an information processing method that shorten a learning time and an estimation time by reducing the size of a neural network.

### Solutions to Problems

The present technology provides an information processing apparatus including a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

The learning model may output the position information for each step in which the controlled device moves.

The position information may include coordinate information where the controlled device is located.

The position information may include posture information of the controlled device.

The learning model may be a neural network.

The controlled device may be a robot.

The obstacle information may include a distance and a direction from each of a plurality of links included in the robot to the closest obstacle.

An obstacle information generation unit that acquires environment information regarding an environment around the controlled device and generates the obstacle information may be further included.

The obstacle information generation unit may generate the obstacle information by using a signed distance field.

The obstacle information generation unit may convert an occupancy grid into a Voronoi grid, and generate the obstacle information on the basis of the Voronoi grid.

The information processing apparatus may further include a storage unit that stores the obstacle information, in which the learning model may receive the obstacle information stored in the storage unit and output the position information.

Furthermore, the present technology provides a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

Furthermore, the present technology provides an information processing method including learning by a computer using a learning model, in which the learning model receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

According to the present technology, it is possible to provide an information processing apparatus, a learning model, and an information processing method that shorten a learning time and an estimation time by reducing the size of a neural network. Note that the effects described here are not necessarily restrictive, and may be any of the effects described with respect to the present technology.

### BRIEF DESCRIPTION OF DRAWINGS

FIG. 1 is a conceptual diagram illustrating a learning model 11 included in an information processing apparatus according to an embodiment of the present technology.

FIG. 2 is a schematic diagram illustrating processing of the information processing apparatus according to the embodiment of the present technology.

FIG. 3 is a block diagram illustrating a configuration example of the information processing apparatus according to the embodiment of the present technology.

FIG. 4 is a block diagram illustrating a hardware configuration example of the information processing apparatus according to the embodiment of the present technology.

FIG. 5 is a block diagram illustrating a configuration example of the information processing apparatus according to an embodiment of the present technology.

FIG. 6 is a schematic diagram illustrating an example of processing of an obstacle information generation unit according to the embodiment of the present technology.

FIG. 7 is a schematic diagram illustrating an example of processing of an obstacle information generation unit according to the embodiment of the present technology.

FIG. 8 is a block diagram illustrating a configuration example of the information processing apparatus according to an embodiment of the present technology.

FIG. 9 is a flowchart illustrating an example of an information processing method according to the embodiment of the present technology.

### MODE FOR CARRYING OUT THE INVENTION

Hereinafter, preferred embodiments for carrying out the present technology will be described with reference to the drawings. Note that an embodiment described below illustrates an example of a representative embodiment of the present technology, and the scope of the present technology is not limited by this. Furthermore, the present technology can combine any of the following embodiments and modifications thereof.

In the drawings, unless otherwise specified, “upper” means upward or an upper side in the drawings, “lower” means downward or a lower side in the drawings, “left” means leftward or a left side in the drawings, and “right” means rightward or a right side in the drawings. Furthermore, in the description using the drawings, the same or equivalent elements or members are designated by the same reference numerals, and duplicate descriptions will be omitted.

The description will be given in the following order.
1. Outline of Present Technology
2. First Embodiment (Example 1 of Information Processing Apparatus)
3. Second Embodiment (Example 2 of Information Processing Apparatus)
4. Third Embodiment (Example 3 of Information Processing Apparatus)
5. Fourth Embodiment (Example of Learning Model)
6. Fifth Embodiment (Example of Information Processing Method)

### 1. Outline of Present Technology

Conventionally, for example, a neural network is used for motion planning of a controlled device such as a robot. 3D or 2D map data related to the environment around the controlled device is input to the neural network. As the map data, for example, voxel data, polygon data, pixel data, or the like is used.

The map data generally includes information regarding the entire environment. In order to capture many features of the environment at high resolution, large-sized map data is required. Since the information regarding the entire environment is input to the neural network, there is a problem that the number of neurons in the input layer increases and the size of the neural network increases accordingly. As a result, the processing time for the neural network to learn or estimate becomes long.

In the present technology, obstacle information including, for example, a distance and a direction from a controlled device such as a robot to the closest obstacle is input to the learning model instead of map data including information regarding the entire environment. Thus, the size of the learning model is significantly reduced. As a result, the learning time and the estimation time by the learning model are significantly shortened. In addition, even in a small robot having limited resources used for processing such as learning and estimation, high-speed processing can be performed.

### 2. First Embodiment (Example 1 of Information Processing Apparatus)

The present technology provides an information processing apparatus including a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

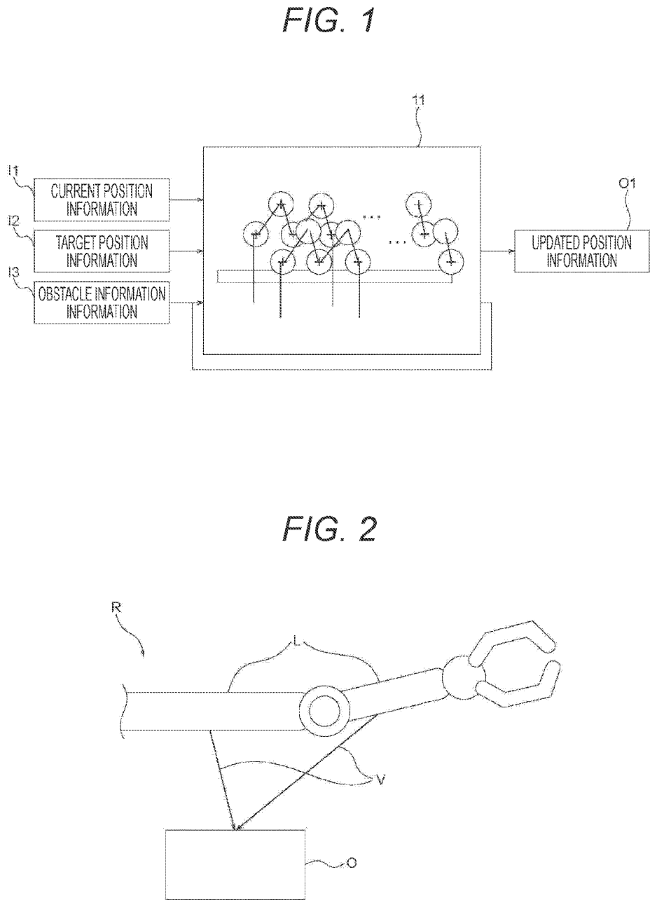

A learning model included in an information processing apparatus according to an embodiment of the present technology will be described with reference to FIG. 1. FIG. 1 is a conceptual diagram illustrating a learning model 11 included in the information processing apparatus according to the embodiment of the present technology. As illustrated in FIG. 1, to the learning model 11 included in the information processing apparatus according to the embodiment of the present technology, current position information I1 of a controlled device, target position information I2 including position information of a movement destination of the controlled device, and obstacle information I3 including a distance and a direction from the controlled device to a closest obstacle are input. Then, the learning model 11 outputs the position information O1 updated in such a manner that the controlled device moves to the movement destination while avoiding the obstacle.

The position information I1, I2, and O1 input to the learning model 11 and output by the learning model 11 include coordinate information where the controlled device is located. The coordinate information may be X, Y, and Z coordinates in a 3D space, or may be X and Y coordinates in a 2D space.

Alternatively, the position information I1, I2, and O1 include posture information of the controlled device. The posture information may be, for example, quaternion of each of a plurality of joints included in the controlled device.

The target position information I2 input to the learning model 11 includes position information of a movement destination of the controlled device. The controlled device moves toward the movement destination. The target position information I2 may be input by the user, or may be autonomously determined by the controlled device.

The controlled device may be, for example, a robot. Examples of the robot include an industrial robot, a cleaning robot, an autonomous robot agent, an automated driving robot, and an automated vehicle. In addition, the robot includes any robot that moves while avoiding an obstacle.

The obstacle information I3 input to the learning model 11 includes a distance and a direction from each of a plurality of links included in the robot to the closest obstacle. This point will be described with reference to FIG. 2. FIG. 2 is a schematic diagram illustrating processing of the information processing apparatus according to the embodiment of the present technology. As illustrated in FIG. 2, a distance and a direction from each of a plurality of links L included in a robot R to the surface of a closest obstacle O are indicated by a distance vector V. The distance vector V can be input to the learning model 11 as the obstacle information I3.

Moreover, the learning model 11 can output the position information for each step in which the controlled device moves. That is, the learning model 11 does not output a series of movement routes including a plurality of steps, but receives input of the obstacle information I3 for each step and outputs the updated position information O1. By repeating the input of the obstacle information I3 and the output of the position information O1 for each step, the controlled device moves to the movement destination while avoiding the obstacle. Since a series of movement paths including a plurality of steps is not output, the size of the output data is reduced. As a result, the size of the learning model 11 further decreases.

As described above, the learning model 11 can be generated by using data including current position information of a controlled device, target position information including position information of a movement destination of the controlled device, obstacle information including a distance and a direction from the controlled device to a closest obstacle, and the position information updated in such a manner that the controlled device moves to the movement destination while avoiding the obstacle. The method of generating the learning model 11 is not particularly limited, but for example, supervised learning using teacher data in which the obstacle information I3 and the position information O1 are associated with each other may be used. Alternatively, reinforcement learning that gives a reward when moving while avoiding an obstacle may be used. As reinforcement learning, for example, a bandit algorithm, Q-learning, salsa, Monte Carlo method, or the like can be used.

Although a form of the learning model 11 is not particularly limited, for example, various neural networks such as an artificial neural network (ANN), a deep neural network (DNN), a convolutional neural network (CNN), and a recurrent neural network (RNN) may be used. Decision tree learning such as ID3 or random forest, correlation rule learning, or the like may be used. Alternatively, genetic programming (GP), inductive logic programming (ILP), a fuzzy algorithm, an evolutionary algorithm (EA), reinforcement learning, a support vector machine (SVM), clustering, a Bayesian network, or the like may be used. Furthermore, a combination of these technologies or a development of these technologies using a deep learning technology may be used.

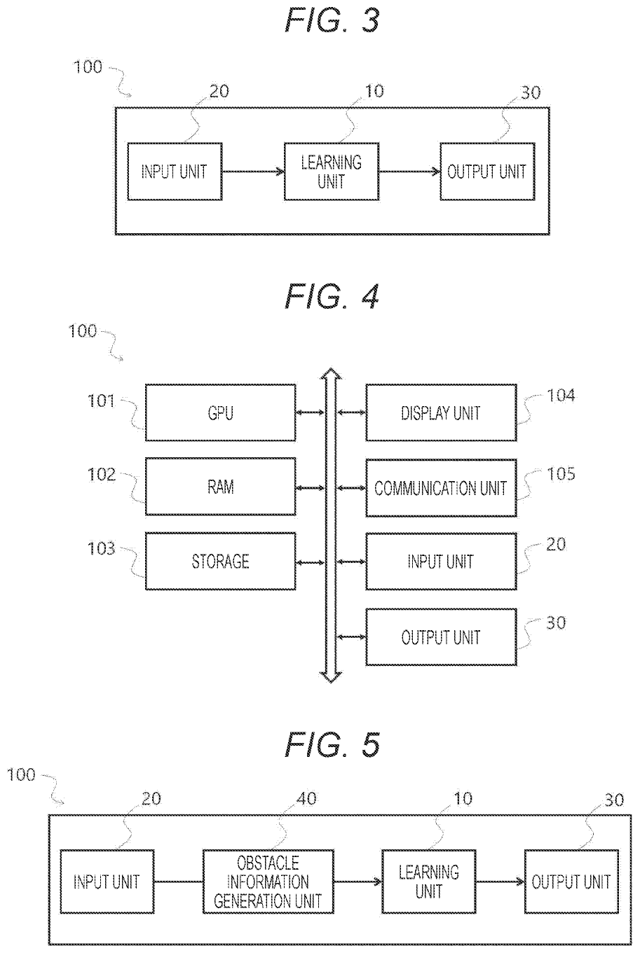

A configuration example of the information processing apparatus according to the embodiment of the present technology will be described with reference to FIG. 3. FIG. 3 is a block diagram illustrating a configuration example of the information processing apparatus 100 according to the embodiment of the present technology. As illustrated in FIG. 3, the information processing apparatus 100 according to the embodiment of the present technology includes an input unit 20, a learning unit 10, and an output unit 30. Note that this configuration is merely an example, and can be flexibly modified according to specifications and operations.

The input unit 20 receives information to be input to the learning model 11. The information includes, for example, position information of the controlled device, operation information by the user, obstacle information, image information, and the like.

The learning unit 10 has a function of learning the position information using the learning model. The learning unit 10 performs learning based on obstacle information including a distance and a direction from the controlled device to the closest obstacle, and outputs the position information updated in such a manner that the controlled device moves to the movement destination while avoiding the obstacle.

The output unit 30 drives the controlled device on the basis of the position information 01 output by the learning model 11. Thus, the controlled device changes the position and posture.

Although not illustrated, the information processing apparatus 100 may include a control unit that controls each component. This control unit can be implemented by using, for example, a CPU, a GPU, or the like.

The information processing apparatus 100 according to the embodiment of the present technology can be implemented by using a program and hardware. A hardware configuration of the information processing apparatus 100 will be described with reference to FIG. 4. FIG. 4 is a block diagram illustrating a hardware configuration example of the information processing apparatus 100 according to the embodiment of the present technology. As illustrated in FIG. 4, the information processing apparatus 100 can include, as components, a GPU 101, a RAM 102, a storage 103, a display unit 104, a communication unit 105, the input unit 20, the output unit 30, and the like. The respective components are connected by, for example, a bus as a data transmission path.

The GPU 101 controls each component of the information processing apparatus 100. The GPU 101 can also function as the learning unit 10. The learning model 11 is implemented by, for example, a program. The GPU 101 functions as the learning unit 10 by reading this program.

The RAM 102 temporarily stores, for example, a program and the like executed by the GPU 101.

The storage 103 stores various data necessary for processing of the GPU 101, such as a learning model. The storage 103 can be implemented by using, for example, a storage device or the like.

The display unit 104 displays information to the user. The display unit 104 is implemented by, for example, a liquid crystal display (LCD), an organic light-emitting diode (OLED), or the like.

The communication unit 105 receives information transmitted from the controlled device. The communication unit 105 has a function of communicating via an information communication network using a communication technology such as Wi-Fi, Bluetooth (registered trademark), or long term evolution (LTE), for example.

The input unit 20 can be implemented by using, for example, a sensor, a camera, a keyboard, a mouse, a touch panel, a joystick, or the like. Examples of the sensor include an optical sensor including an imaging sensor and an infrared sensor, an acceleration sensor, a gyro sensor, a geomagnetic sensor, a thermal sensor, a vibration sensor, a global navigation satellite system (GNSS) signal receiver, and the like.

The output unit 30 can be implemented by using, for example, a motor or the like.

The information processing apparatus 100 according to the embodiment of the present technology can be, for example, a computer such as a robot, a smartphone terminal, a tablet terminal, a mobile phone terminal, a personal digital assistant (PDA), a personal computer (PC), a server, or a wearable terminal (Head Mounted Display (HMD), glasses-type HMD, watch-type terminal, band-type terminal, and the like).

In addition, the information processing apparatus according to the embodiment of the present technology may be included in the controlled device. That is, the learning model can be provided in a robot that is an example of the controlled device.

The above content described for the information processing apparatus according to the first embodiment of the present technology can be applied to other embodiments of the present technology as long as there is no technical contradiction.

### 3. Second Embodiment (Example 2 of Information Processing Apparatus)

The information processing apparatus according to an embodiment of the present technology can further include an obstacle information generation unit that acquires environment information regarding an environment around the controlled device and generates the obstacle information. This point will be described with reference to FIG. 5. FIG. 5 is a block diagram illustrating a configuration example of the information processing apparatus 100 according to the embodiment of the present technology. As illustrated in FIG. 5, the information processing apparatus 100 according to the embodiment of the present technology further includes an obstacle information generation unit 40. The obstacle information generation unit 40 acquires environment information regarding the environment around the controlled device obtained by the input unit 20, and generates the obstacle information. The obstacle information generation unit 40 can be implemented by using, for example, a GPU.

Means for generating the obstacle information is not particularly limited, but for example, the obstacle information generation unit 40 can generate the obstacle information using a signed distance field (SDF).

SDF stores a distance grid in 3D space. The distance grid includes the distance to the nearest obstacle. For example, the distance grid can be calculated on the basis of 3D mesh data using the technology described in Non-Patent Document 3 below.

### Non-Patent Document 3

“Generating Signed Distance Fields From Triangle Meshes”, IMM-TECHNICAL REPORT, 2002

Alternatively, the obstacle information generation unit 40 can convert an occupancy grid into a Voronoi grid and generate the obstacle information on the basis of the Voronoi grid.

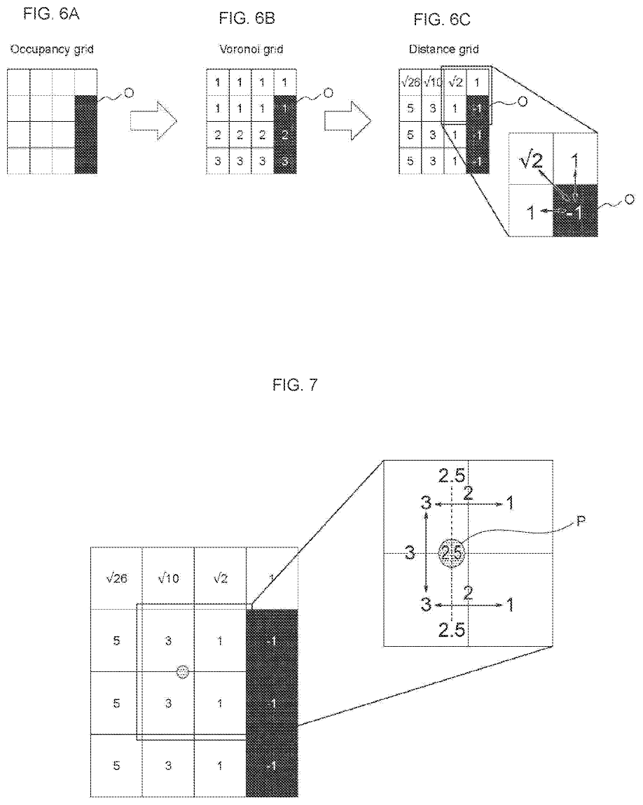

This point will be described with reference to FIG. 6. FIG. 6 is a schematic diagram illustrating an example of processing of the obstacle information generation unit 40 according to the embodiment of the present technology.

The obstacle information generation unit 40 converts the occupancy grid (FIG. 6A) obtained from, for example, a camera with a depth sensor, a LiDER, or the like into a Voronoi grid (FIG. 6B).

In the occupancy grid illustrated in FIG. 6A, the cell including the obstacle O is filled in black.

In the Voronoi grid illustrated in FIG. 6B, a unique number is assigned to a cell including the obstacle O. In this drawing, three cells include the obstacle O, and unique numbers are assigned in order from the top.

The number assigned to the closest cell among the numbers assigned to the cells including the obstacle O is assigned to a free space cell not including the obstacle.

For example, the occupancy grid can be converted into a Voronoi grid using the technology described in Non-Patent Document 4 below.

### Non-Patent Document 4

T. Cao, K. Tang, A. Mohamed, T. Tan, “Parallel Banding Algorithm to Compute Exact Distance Transform with the GPU”, Association for Computing Machinery, 2010, pp. 83-90

The obstacle information generation unit 40 can generate a distance grid (FIG. 6C) by calculating a distance between each free space cell and a cell including the closest obstacle indicated by the number assigned to the cell on the basis of the Voronoi grid.

When the distance grid is generated, the distance from any point in the distance grid to the obstacle can be calculated. This calculation method is not particularly limited, but in the 2D space, for example, bilinear interpolation or the like can be used. In the 3D space, for example, trilinear interpolation or the like can be used.

A result of calculating the distance using the bilinear complement method will be described with reference to FIG. 7. FIG. 7 is a schematic diagram illustrating an example of processing of the obstacle information generation unit 40 according to the embodiment of the present technology. As illustrated in FIG. 7, the distance from a point P to the closest obstacle is calculated as 2.5.

A distance vector indicating a distance and a direction from any point in the distance grid to the closest obstacle is obtained by calculating a gradient of the point. The distance vector is obtained by multiplication of distance and normalization (gradient). Here, normalization refers to normalization of a vector length for making the length equal to 1. A gradient is obtained by using a finite difference method and a gradient formula.

The above content described for the information processing apparatus according to the second embodiment of the present technology can be applied to other embodiments of the present technology as long as there is no technical contradiction.

### 4. Third Embodiment (Example 3 of Information Processing Apparatus)

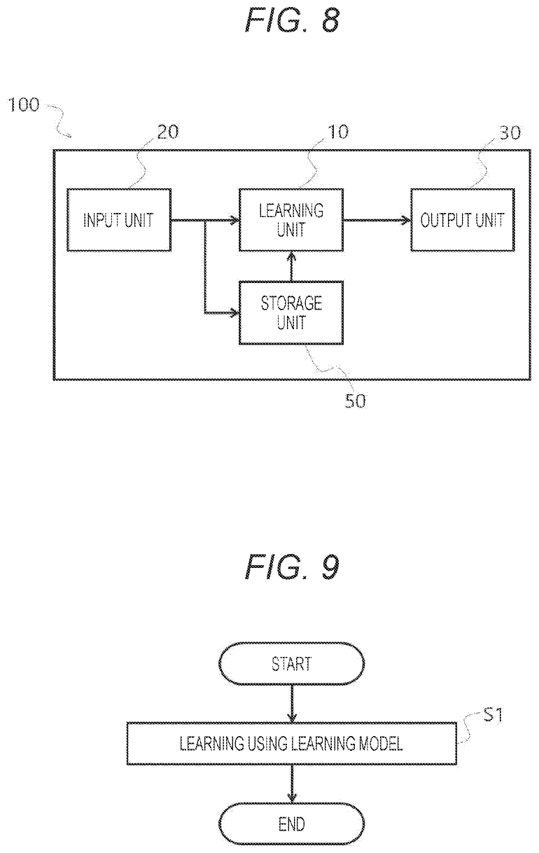

The information processing apparatus according to an embodiment of the present technology further includes a storage unit that stores the obstacle information, in which the learning model can receive the obstacle information stored in the storage unit and output the position information. This point will be described with reference to FIG. 8. FIG. 8 is a block diagram illustrating a configuration example of the information processing apparatus 100 according to the embodiment of the present technology. As illustrated in FIG. 8, the information processing apparatus 100 according to the embodiment of the present technology includes a storage unit 50 that stores obstacle information. The obstacle information stored in the storage unit 50 is input to the learning model 11, and the learning model 11 can output the position information updated on the basis of the obstacle information. The storage unit 50 can be implemented by using, for example, a storage device or the like.

Since it is not necessary to acquire the environment information regarding the environment around the controlled device, the processing speed of the information processing apparatus 100 is improved. For example, when there is a U-shaped obstacle, the shape of the entire obstacle can be stored in the storage unit 50. Thus, the input of the obstacle information from the input unit 20 is omitted. As a result, the processing speed of the information processing apparatus 100 is improved.

The above content described for the information processing apparatus according to the third embodiment of the present technology can be applied to other embodiments of the present technology as long as there is no technical contradiction.

### 5. Fourth Embodiment (Example of Learning Model)

The present technology provides a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle. Since this learning model has been described in the first embodiment and the like, the description thereof will be omitted again.

A learning model according to an embodiment of the present technology can be implemented by a program. This program may be stored in another computer or computer system. In this case, the computer can use a cloud service that provides the function of the program. Examples of the cloud service include software as a service (Saas), infrastructure as a service (IaaS), and platform as a service (PaaS), and the like.

Alternatively, the learning model may be stored in an edge server. A learned model learned by a cloud may be stored in the edge server, or a learning model stored in the edge server may learn.

Furthermore, the program can be stored using various types of non-transitory computer readable media and supplied to the computer. The non-transitory computer readable media include various types of tangible storage media. Examples of the non-transitory computer readable medium include a magnetic recording medium (for example, a flexible disk, a magnetic tape, or a hard disk drive), a magneto-optical recording medium (for example, a magneto-optical disk), a compact disc read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). Furthermore, the above-described program may be supplied to the computer by various types of transitory computer readable media. Examples of transitory computer-readable media include electrical signals, optical signals, and electromagnetic waves. The transitory computer-readable medium can supply the above-described program to the computer via a wired communication path such as an electric wire and an optical fiber, or a wireless communication path.

The above content described for the learning model according to the fourth embodiment of the present technology can be applied to other embodiments of the present technology as long as there is no technical contradiction.

### 6. Fifth Embodiment (Example of Information Processing Method)

The present technology provides an information processing method including learning by a computer using a learning model, in which the learning model receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

An information processing method according to an embodiment of the present technology will be described with reference to FIG. 9. FIG. 9 is a flowchart illustrating an example of an information processing method according to the embodiment of the present technology. As illustrated in FIG. 9, the information processing method according to the embodiment of the present technology includes learning by a computer using a learning model (step S1). There is provided an information processing method, in which a learning model receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

The information processing method according to the embodiment of the present technology can use the technology according to the other embodiment described above. Thus, the description will be omitted again.

The above content described for the information processing method according to the fifth embodiment of the present technology can be applied to other embodiments of the present technology as long as there is no technical contradiction.

Note that the embodiments according to the present technology are not limited to the above-described embodiments, and various modifications can be made without departing from the gist of the present technology.

Furthermore, the effects described in the present specification are merely examples and are not limited to any particular effects, and there may be some other effects.

Furthermore, the present technology can also have the following configurations.

[1]

An information processing apparatus, including a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

[2]

The information processing apparatus according to [1], in which
the learning model outputs the position information for each step in which the controlled device moves.

[3]

The information processing apparatus according to [1] or [2], in which
the position information includes coordinate information where the controlled device is located.

[4]

The information processing apparatus according to any one of [1] to [3], in which
the position information includes posture information of the controlled device.

[5]

The information processing apparatus according to any one of [1] to [4], in which
the learning model is a neural network.

[6]

The information processing apparatus according to any one of [1] to [5], in which
the controlled device is a robot.

[7]

The information processing apparatus according to [6], in which
the obstacle information includes a distance and a direction from each of a plurality of links included in the robot to the closest obstacle.

[8]

The information processing apparatus according to any one of [1] to [7], further including:
an obstacle information generation unit that acquires environment information regarding an environment around the controlled device and generates the obstacle information.

[9]

The information processing apparatus according to [8], in which
the obstacle information generation unit generates the obstacle information by using a signed distance field.

[10]

The information processing apparatus according to [8], in which
the obstacle information generation unit converts an occupancy grid into a Voronoi grid, and generates the obstacle information on the basis of the Voronoi grid.

[11]

The information processing apparatus according to any one of [1] to [10], further including:
a storage unit that stores the obstacle information, in which
the learning model receives input of the obstacle information stored in the storage unit and outputs the position information.

[12]

A learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

[13]

An information processing method including learning by a computer using a learning model, in which
the learning model receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

[14]

A learning model generation method including generating a learning model by using data including current position information of a controlled device, target position information including position information of a movement destination of the controlled device, obstacle information including a distance and a direction from the controlled device to a closest obstacle, and the position information updated in such a manner that the controlled device moves to the movement destination while avoiding the obstacle.

### REFERENCE SIGNS LIST

I1 Current position information
I2 Target position information
I3 Obstacle information
O1 Position information
100 Information processing apparatus
10 Learning unit
11 Learning model
20 Input unit
30 Output unit
40 Obstacle information generation unit
50 Storage unit
S1 Learning using a learning model

1. An information processing apparatus, comprising a learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

2. The information processing apparatus according to claim 1, wherein
the learning model outputs the position information for each step in which the controlled device moves.

3. The information processing apparatus according to claim 1, wherein
the position information includes coordinate information where the controlled device is located.

4. The information processing apparatus according to claim 1, wherein
the position information includes posture information of the controlled device.

5. The information processing apparatus according to claim 1, wherein
the learning model is a neural network.

6. The information processing apparatus according to claim 1, wherein
the controlled device is a robot.

7. The information processing apparatus according to claim 6, wherein
the obstacle information includes a distance and a direction from each of a plurality of links included in the robot to the closest obstacle.

8. The information processing apparatus according to claim 1, further comprising:
an obstacle information generation unit that acquires environment information regarding an environment around the controlled device and generates the obstacle information.

9. The information processing apparatus according to claim 8, wherein
the obstacle information generation unit generates the obstacle information by using a signed distance field.

10. The information processing apparatus according to claim 8, wherein
the obstacle information generation unit converts an occupancy grid into a Voronoi grid, and generates the obstacle information on a basis of the Voronoi grid.

11. The information processing apparatus according to claim 1, further comprising:
a storage unit that stores the obstacle information, wherein
the learning model receives input of the obstacle information stored in the storage unit and outputs the position information.

12. A learning model that receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.

13. An information processing method comprising learning by a computer using a learning model, wherein
the learning model receives input of current position information of a controlled device, target position information including position information of a movement destination of the controlled device, and obstacle information including a distance and a direction from the controlled device to a closest obstacle, and outputs the position information updated in such a manner that the controlled device moves to the movement destination while avoiding the obstacle.
